(19) United States
(12) Patent Application Publication
(10) Pub. No.: US 2018/0001409 A1
(43) Pub. Date: Jan. 4, 2018

(54) SOLDERING DEVICE

(71) Applicant: Primax Electronics Ltd., Taipei (TW)

(72) Inventors: CHENG -YI TSAI, Taipei (TW); YING-CHE TSENG, Taipei (TW)

(21) Appl. No.: 15/292,604

(22) Filed: Oct. 13, 2016

(30) Foreign Application Priority Data
Jul. 1, 2016 (TW) 105120920

(51) Int. Cl. B23K 3/03; G05B 19/4063; B23K 101/40

(52) U.S. Cl. CPC B23K 3/033; G05B 19/4063; B23K 2201/40; G05B 2219/50193

(57) ABSTRACT

A soldering device includes a main body, a soldering tip, an image capturing module, a display, a microcontroller and a database. The database is stored in the microcontroller. The database contains the images of plural objects and plural soldering tip data corresponding to the plural objects. The image capturing module captures an image of a target object to be soldered. The microcontroller compares the image of the target object with the images in the database, and shows the soldering tip data corresponding to the image of the target object on the display. According to the message shown on the display, the user selects the suitable soldering tip. The soldering device is selectively operated in an automatic replacing mode or a manual replacing mode. In the automatic replacing mode, the soldering tips can be automatically replaced. Consequently, the soldering device can accurately and quickly select the suitable soldering tip.

### FIELD OF THE INVENTION

The present invention relates to a soldering device.

### BACKGROUND OF THE INVENTION

A soldering device is used for soldering electronic components on a circuit board. Consequently, the electronic components can be electrically connected with electric traces of the circuit board. A process of using the soldering device to solder an electronic component on a circuit board will be described as follows. Firstly, a pin of the electronic component is aligned with a position to be soldered. Then, a soldering tip of the soldering device is aligned with the soldered position. Then, the molten soldering material drops down to the soldered position. Consequently, the electronic device is soldered on the circuit board.

Generally, in case that the specifications of the electronic components are different, the pins of the electronic components have different sizes and different arrangements. For accurately placing the soldering material on the soldered position, the soldering tip with a proper size is selected to solder the corresponding electronic component.

However, the conventional soldering device still has some drawbacks. For example, it is necessary for the user to manually select the model number of the soldering tip that is suitable for soldering the electronic component. The way of manually selecting the suitable soldering tip may result in misjudgment. Because of misjudgment, the improper soldering tip is selected. Moreover, the process of replacing the soldering tip is manually performed. In other words, the soldering efficiency of using the conventional soldering device is not satisfied.

### SUMMARY OF THE INVENTION

The present invention provides a soldering device for facilitating accurately and quickly replacing a soldering tip.

In accordance with an aspect of the present invention, there is provided a soldering device. The soldering device includes a main body, a soldering tip, an image capturing module, a display, a microcontroller and a database. The soldering tip is located at an end of the main body. The image capturing module is located near the end of the main body. An image of a target object to be soldered is captured by the image capturing module. The display is disposed on the main body. The microcontroller is disposed within the main body and electrically connected with the image capturing module and the display. The database is stored in the microcontroller. The database contains images of plural objects and plural soldering tip data corresponding to the objects. The soldering tip data of the database corresponding to the image of the target object is shown on the display by the microcontroller according to the image of the target object captured by the image capturing module. Then, the soldering device is selectively operated in an automatic replacing mode or a manual replacing mode.

In an embodiment, the soldering device further includes a channel and an opening. The channel is disposed within the main body. The opening is formed in the main body and in communication with the channel. A solder wire is introduced into the channel through the opening. Preferably, the soldering device further includes a circuit board, and the microcontroller is disposed on the circuit board. Preferably, the soldering device further includes a temperature control module, and the temperature control module is disposed on the circuit board. Preferably, the soldering device further includes a heating rod, and the heating rod is disposed within the main body, wherein a temperature of the heating rod is adjusted by the temperature control module.

In an embodiment, the soldering device is operated in the manual replacing mode, and the microcontroller controls the temperature control module to decrease the temperature of the heating rod. The soldering device further includes a switch element and a key. The switch element is disposed on the circuit board. The key is disposed on the main body and at a position corresponding to the switch element. The switch element is triggered to generate a switch signal when the key is pressed. After the temperature of the heating rod is decreased, the microcontroller controls the temperature control module to increase the temperature of the heating rod in response to the switch signal. When the temperature of the heating rod increases to a working temperature, a start use message is shown on the display.

In an embodiment, the soldering device further includes a turntable, and the turntable is disposed within the main body to carry plural candidate soldering tips. The turntable includes plural identification chips corresponding to the plural candidate soldering tips. Each identification chip stores a model number of the corresponding candidate soldering tip. In the automatic replacing mode, the soldering tip at the end of the main body is received within the main body, and the candidate soldering tip with the shown soldering tip data and carried on the turntable is selected and pushed out of the main body.

Preferably, the soldering tip data includes a model number of the soldering tip. The image stored in the database includes an image of a surface mount technology (SMT) package device or a pin image of a dual pin-line (DIP) package device. The main body is a tubular body.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a soldering device according to an embodiment of the present invention;

FIG. 2 schematically illustrates a database stored in the microcontroller of the soldering device;

FIG. 3A schematically illustrates a turntable carrying plural soldering tips according to an embodiment of the present invention;

FIG. 3B schematically illustrating the turntable of FIG. 3A, in which one soldering tip is pushed; and

FIG. 4 is a flowchart illustrating a method of replacing the soldering tip according to an embodiment of the present invention.

### DETAILED DESCRIPTION OF THE PREFERRED EMBODIMENT

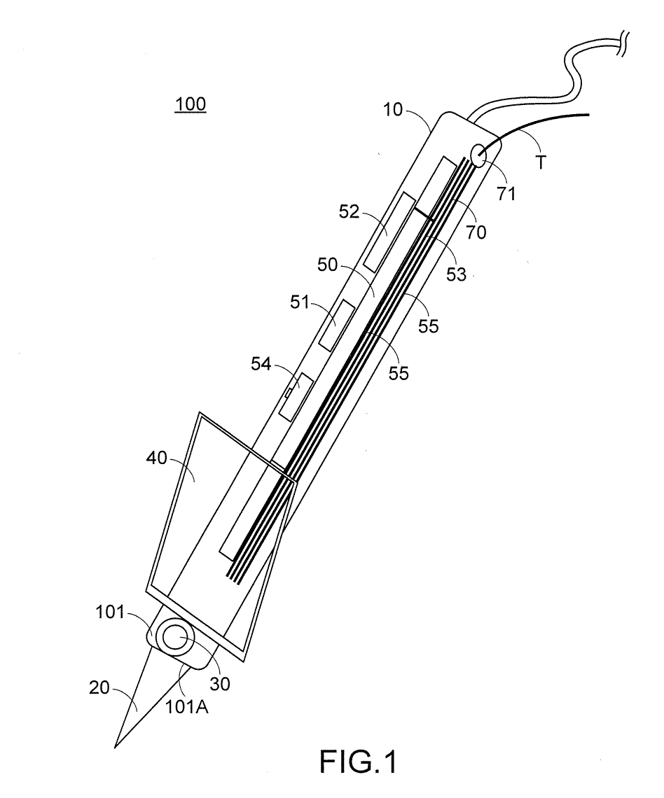

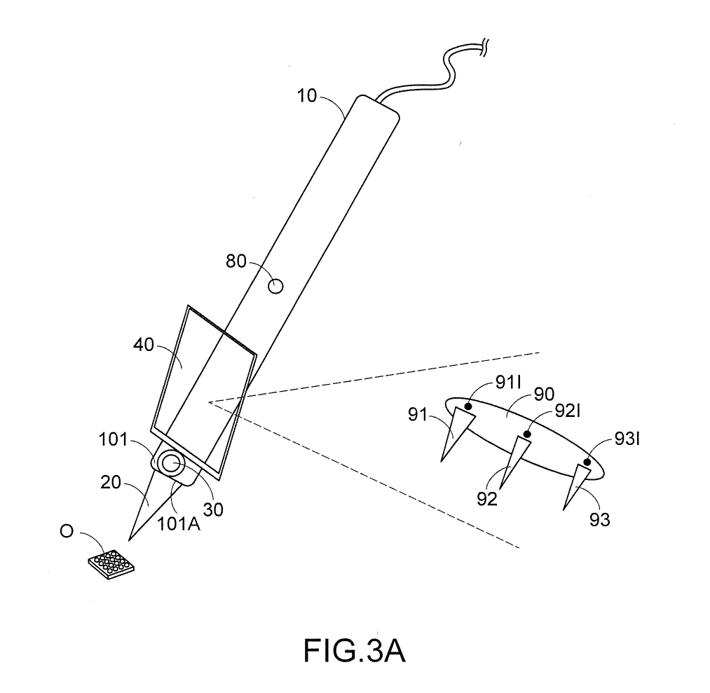

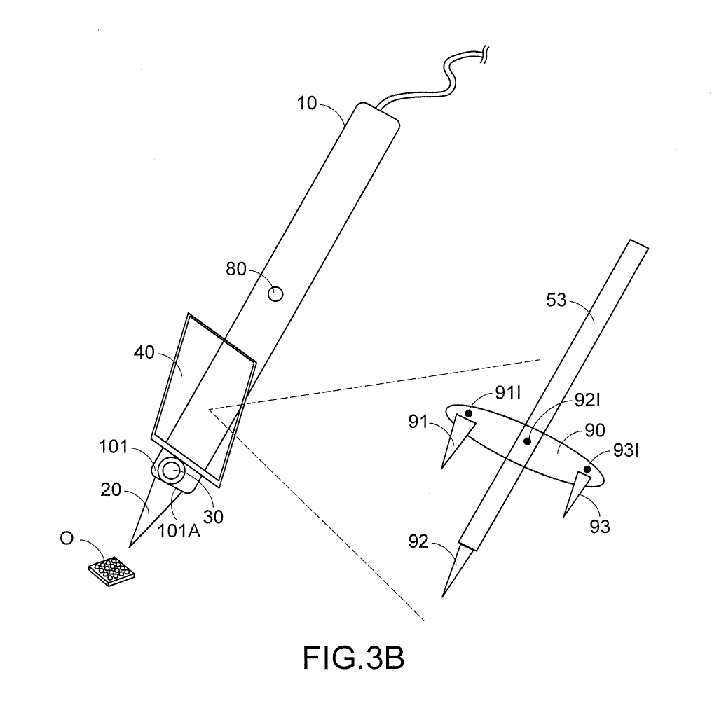

FIG. 1 is a schematic view illustrating a soldering device according to an embodiment of the present invention. As shown in FIG. 1, the soldering device 100 comprises a main body 10, a soldering tip 20, an image capturing module 30, a display 40, a circuit board 50, a heating rod 53, a channel 70 and an opening 71. The opening 71 is in communication of the channel 70. Moreover, a microcontroller 51, a temperature control module 52 and a switch element 54 are installed on the circuit board 50. A key 80 (see FIG. 3A) is disposed on a surface of the main body 10 and at the position corresponding to the switch element 54. Moreover, the soldering device 100 further comprises a heat insulation layer 55 for covering the heating rod 53 and the channel 70.

Please refer to FIG. 1 again. In this embodiment, the main body 10 is a tubular body. Consequently, the user can grasp the main body 10 to perform a soldering task. The soldering tip 20 is located at an end 101 of the main body 10. A soldering material such as a solder wire T can be introduced into the channel 70 of the main body 10 through the opening 71. By the temperature control module 52, the temperature of the heating rod 53 is increased to the melting point of the solder wire T. After the solder wire T is molten, the molten soldering material drops off to the soldered position along a surface of the soldering tip 20. Consequently, the soldered object is fixed on a specified position. The image capturing module 30 is located near the end 101 of the main body 10 and electrically connected with the circuit board 50. The display 40 is also located near the located near the end 101 of the main body 10 and electrically connected with the circuit board 50.

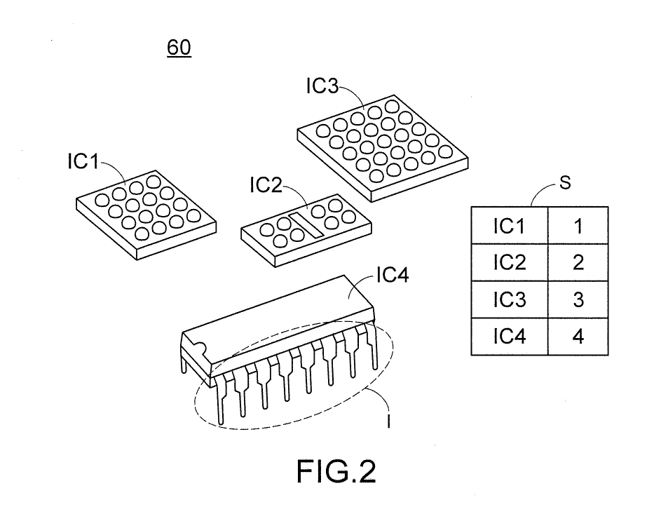

FIG. 2 schematically illustrates a database stored in the microcontroller of the soldering device. As shown in FIG. 2, the database 60 contains the images of plural objects and plural soldering tip data corresponding to the objects. For example, the plural soldering tip data include the model numbers of the corresponding soldering tips. In the database 60 of FIG. 2, the objects comprise two types of integrated circuit package devices. For example, the package devices IC1, IC2 and IC3 are surface mount technology (SMT) package devices, and the package device IC4 is a dual pin-line (DIP) package device. In case that the soldered object is the SMT package device, the image of the SMT package device is previously stored in the database 60. In case that the soldered object is the DIP package device, the pin image I of the DIP package device is previously stored in the database 60 because the model number of the soldering tip suitable for the DIP package device can be realized according to the pin image. Moreover, the database 60 further contains the soldering tip data S corresponding to the soldered objects. As shown in FIG. 2, the package devices IC1, 1C2, IC3 and IC4 are suitably soldered by the soldering tips with the model numbers 1, 2, 3 and 4, respectively.

FIGS. 3A and 3B schematically illustrate a turntable carrying plural soldering tips according to an embodiment of the present invention. As shown in FIGS. 3A and 3B, plural candidate soldering tips are carried on the turntable 90. In this embodiment, the plural candidate soldering tips comprise the soldering tips 91, 92 and 93. Moreover, the turntable 90 comprises identification chips 91I, 92I and 93I at the positions corresponding to the soldering tips 91, 92 and 93. The identification chips store the model numbers of the corresponding soldering tips. That is, the model number of the soldering tip 91 is stored in the identification chip 91I, the model number of the soldering tip 92 is stored in the identification chip 92I, and the model number of the soldering tip 93 is stored in the identification chip 93I. It is noted that the amount of candidate soldering tips carried on the turntable 90 is not restricted. That is, the amount of candidate soldering tips carried on the turntable 90 may be varied according to the practical requirements.

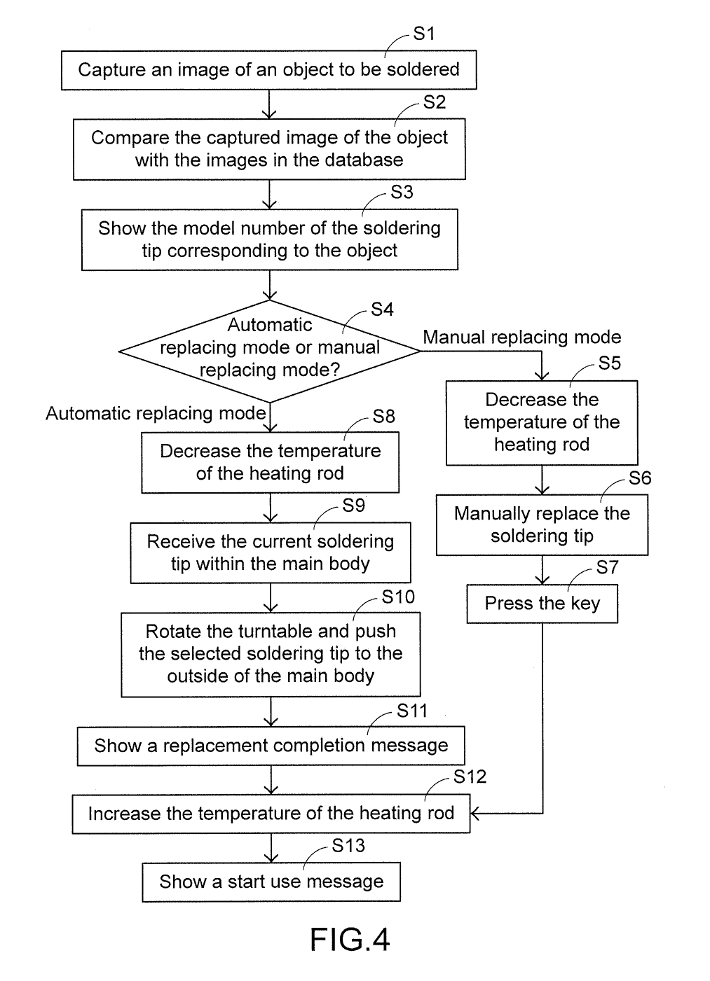

FIG. 4 is a flowchart illustrating a method of replacing the soldering tip according to an embodiment of the present invention. The method of replacing the soldering tip will be illustrated with reference to FIGS. 1, 2, 3A, 3B and 4. As shown in FIG. 1, the soldering device 100 comprises the display 40. The information about the operating procedures can be shown on the display 40 by the microcontroller 50. According to the information shown on the display 40, the user can perform the method of replacing the soldering tip. When the key 80 is pressed by the user, the switch element 54 is triggered to generate a switch signal. According to the guidance of the microcontroller 50, the following steps will be performed.

Firstly, the image capturing module 30 captures an image of an object O to be soldered (Step S1). Then, the image of the object O is transmitted to the microcontroller 51, and the image of the object O is compared with the images in the database 60. In an embodiment, the object O is a SMT package device. After the image of the object O is compared with the images that are previously stored in the database 60, the microcontroller 51 recognizes the model number of the soldering tip suitable for soldering the object O. In addition, the model number of the soldering tip corresponding to the object O is shown on the display 40 by the microcontroller 51 (Step S3). According to the information about the model number of the soldering tip corresponding to the object O, the user can directly realize which soldering tip is suitable for soldering the object O. In accordance with the present invention, two operation modes of replacing the soldering tip are provided. That is, the method of replacing the soldering tip is selectively operated in an automatic replacing mode or a manual replacing mode (Step S4). In an embodiment, the default operation mode of the microcontroller 51 is the automatic replacing mode.

The operations of the soldering device in the automatic replacing mode will be described with reference to FIGS. 3A and 3B. As shown in FIG. 3A, the soldering tip 92 is the candidate soldering tip that is suitable for soldering the object O. Before the soldering tip is replaced, the microcontroller 51 controls the temperature control module 52 to decrease the temperature of the heating rod 53 (Step S8). Consequently, during the process of replacing the soldering tip, the device or the user will not be injured by the high temperature. In the automatic replacing mode, the turntable 90 is firstly pulled into the inside of the main body 10 by a driving mechanism (not shown) of the soldering device 100, and thus the current soldering tip 20 is received within the main body 10 (Step S9). Then, according to the model number of the soldering tip 92 stored in the identification chip 92I of the turntable 90, the microcontroller 51 recognizes which soldering tip carried on the turntable 90 is the soldering tip 92. Moreover, the turntable 90 is moved toward the end 101 of the main body 10 by the driving mechanism within the main body 10. Then, the soldering tip 92 is pushed by the heating rod 53, and thus the soldering tip 92 is protruded out of an aperture 101A of the end 101 of the main body 10. Meanwhile, the procedure of replacing the soldering tip is completed.

After the soldering tip is replaced, a replacement completion message is shown on the display 40 by the microcontroller 51 (Step S11). Then, the microcontroller 51 controls the temperature control module 52 to increase the temperature of the heating rod 53 (Step S12). When the heating rod 53 reaches its working temperature, a start use message is shown on the display 40 by the microcontroller 51 (Step S13).

In addition to the automatic replacing mode, the user can select the manual replacing mode. The operations in the manual replacing mode will be described as follows. Please refer to FIG. 4. After the user selects the manual replacing mode, the microcontroller 51 also controls the temperature control module 52 to decrease the temperature of the heating rod 53 (Step S5). Then, the current soldering tip is removed by the user with a clamping tool, and the soldering tip 92 having model number of shown on the display 40 is taken out from the aperture 101A of the end 101 of the main body 10 (Step S6). After the soldering tip is replaced, the user may press the key 80 to trigger the switch element 54 to generate the switch signal (Step S7). According to the generation of the switch signal, the microcontroller 51 judges that the procedure of replacing the soldering tip is completed. Consequently, the microcontroller 51 controls the temperature control module 52 to increase the temperature of the heating rod 53 (Step S12). When the heating rod 53 reaches its working temperature, a start use message is shown on the display 40 by the microcontroller 51 (Step S13).

From the above descriptions, the present invention provides a soldering device. The image of the target object to be soldered is captured. The database contains the images of plural objects and the model numbers of the soldering tips corresponding to the objects. By comparing the image of the target object with the images in the database, the accurate model number of the soldering tip suitable for soldering the target object can be actively provided to the user. Consequently, the misjudgment from the way of manually selecting the soldering tip will be largely reduced. Moreover, in the automatic replacing mode, the soldering tips can be automatically replaced. Under this circumstance, the speed of replacing the soldering tip is increased.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A soldering device, comprising:
a main body;
a soldering tip located at an end of the main body;
an image capturing module located near the end of the main body, wherein an image of a target object to be soldered is captured by the image capturing module;
a display disposed on the main body;
a microcontroller disposed within the main body and electrically connected with the image capturing module and the display; and
a database stored in the microcontroller, wherein the database contains images of plural objects and plural soldering tip data corresponding to the objects, wherein the soldering tip data of the database corresponding to the image of the target object is shown on the display by the microcontroller according to the image of the target object captured by the image capturing module, and then the soldering device is selectively operated in an automatic replacing mode or a manual replacing mode.

2. The soldering device according to claim 1, wherein the soldering device further comprises a channel and an opening, wherein the channel is disposed within the main body, the opening is formed in the main body and in communication with the channel, and a solder wire is introduced into the channel through the opening.

3. The soldering device according to claim 1, wherein the soldering device further comprises a circuit board, and the microcontroller is disposed on the circuit board.

4. The soldering device according to claim 3, wherein the soldering device further comprises a temperature control module, and the temperature control module is disposed on the circuit board.

5. The soldering device according to claim 4, wherein the soldering device further comprises a heating rod, and the heating rod is disposed within the main body, wherein a temperature of the heating rod is adjusted by the temperature control module.

6. The soldering device according to claim 5, wherein in the manual replacing mode, the microcontroller controls the temperature control module to decrease the temperature of the heating rod.

7. The soldering device according to claim 6, wherein the soldering device further comprises a switch element and a key, wherein the switch element is disposed on the circuit board, the key is disposed on the main body and at a position corresponding to the switch element, and the switch element is triggered to generate a switch signal when the key is pressed, wherein after the temperature of the heating rod is decreased, the microcontroller controls the temperature control module to increase the temperature of the heating rod in response to the switch signal, wherein when the temperature of the heating rod increases to a working temperature, a start use message is shown on the display.

8. The soldering device according to claim 5, wherein the soldering device further comprises a turntable, and the turntable is disposed within the main body to carry plural candidate soldering tips, wherein the turntable comprises plural identification chips corresponding to the plural candidate soldering tips, wherein each identification chip stores a model number of the corresponding candidate soldering tip.

9. The soldering device according to claim 8, wherein in the automatic replacing mode, the soldering tip at the end of the main body is received within the main body, and the candidate soldering tip with the shown soldering tip data and carried on the turntable is selected and pushed out of the main body.

10. The soldering device according to claim 9, wherein before the selected soldering tip is pushed, the microcontroller controls the temperature control module to decrease the temperature of the heating rod.

11. The soldering device according to claim 10, wherein after the selected soldering tip is pushed out of the main body, a replacement completion message is shown on the display by the microcontroller, and the microcontroller controls the temperature control module to increase the temperature of the heating rod, wherein when the temperature of the heating rod increases to a working temperature, a start use message is shown on the display.

12. The soldering device according to claim 1, wherein the soldering tip data includes a model number of the soldering tip.

13. The soldering device according to claim 1, wherein the target object is a surface mount technology (SMT) package device or a dual pin-line (DIP) package device.

14. The soldering device according to claim 1, wherein the image stored in the database includes an image of a surface mount technology (SMT) package device or a pin image of a dual pin-line (DIP) package device.

15. The soldering device according to claim 1, wherein the main body is a tubular body.
